(19) United States
(12) Patent Application Publication
(10) Pub. No.: US 2026/0074289 A1
(43) Pub. Date: Mar. 12, 2026

(54) ELECTROLYTE FOR THICK LFP-LITHIUM BATTERY SYSTEM

(71) Applicant: GM Global Technology Operations LLC, Detroit, MI (US)

(72) Inventors: Xin Zhang, Shanghai (CN); Meinan He, Birmingham, MI (US); Yan Wu, Shanghai (CN); Haijing Liu, Shanghai (CN)

(21) Appl. No.: 18/805,943

(22) Filed: Aug. 15, 2024

(30) Foreign Application Priority Data
Aug. 9, 2024 (CN) 202411099168.2

(51) Int. Cl. H01M 10/0568; H01M 4/02; H01M 4/40; H01M 4/58; H01M 4/62; H01M 10/0525; H01M 10/0569

(52) U.S. Cl. CPC H01M 10/0568; H01M 4/405; H01M 4/5825; H01M 4/623; H01M 10/0525; H01M 10/0569; H01M 2004/027; H01M 2004/028; H01M 2300/0037

(57) ABSTRACT

An electrolyte for a thick LFP-Li battery system is provided. The electrolyte includes a low-viscosity main salt, at least one lithium-based functional salt, and a solvent including a low viscosity solvent mixed with a cyclic ether solvent. The low-viscosity main salt includes at least one of LiTFSI or a lithium salt.

### INTRODUCTION

The present disclosure relates to a lithium iron phosphate battery system, and more particularly, to an electrolyte for use within the lithium iron phosphate battery system.

Rechargeable batteries are known to be used in consumer electronic applications from small electronic devices, such as cell phones and laptop computers to larger devices like vehicles. Modern rechargeable lithium-ion batteries have the ability to hold a relatively high energy density as compared to older types of rechargeable batteries such as nickel metal hydride, nickel cadmium, or lead acid batteries. A benefit of rechargeable lithium-ion batteries is that the batteries can be completely or partially charged and discharged over many cycles without retaining a charge memory. In addition, rechargeable lithium-ion batteries can be used in larger applications, such as for electric and hybrid vehicles due to the batteries' high-power density, long cycle life, and ability to be formed into a wide variety of shapes and sizes so as to efficiently fill available space in such vehicles.

Rechargeable lithium-ion batteries utilize an electrolyte to carry or conduct lithium cations (Li⁺) between a cathode active material and an anode active material. In LiFePO4 (LFP-Li) type batteries, a conventional carbonate electrolyte or a high-concentration electrolyte is used. However, issues including thick electrodes and lithium anodes cause LFP-Li batteries to be incompatible with carbonate electrolytes or high-concentration electrolytes, which leads to poor electrochemical performance.

While prior art methods and systems attempt to minimize the disadvantages of employing a carbonate electrolyte or a high-concentration electrolyte and may achieve their particular purpose, a need still exists for a new and improved electrolyte for an LFP-Li battery. Accordingly, a stable and efficient LFP-Li battery is needed.

### SUMMARY

According to several aspects of the present disclosure, an electrolyte for a thick LFP-Li battery system is provided. The electrolyte includes a low-viscosity main salt, at least one lithium-based functional salt, and a solvent including a low viscosity solvent mixed with a cyclic ether solvent. The low-viscosity main salt includes at least one of LiTFSI or a lithium salt and has the following structure.

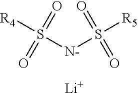

In accordance with another aspect of the disclosure, the electrolyte has a functional group R₄ including at least one of a fluorine (F) atom or a straight-chain C1-C6 fluoroalkyl group.

In accordance with another aspect of the disclosure, the electrolyte has a functional group R₅ including at least one of a fluorine (F) atom or a straight-chain C1-C6 fluoroalkyl group.

In accordance with another aspect of the disclosure, the electrolyte includes a low-viscosity main salt having a concentration between 0.6M to 2.0M.

In accordance with another aspect of the disclosure, the electrolyte includes a low-viscosity main salt having a concentration between 0.8M to 1.2M.

In accordance with another aspect of the disclosure, the electrolyte has a lithium-based functional salt including at least one of lithium difluoro(oxalate)borate (LiDFOB), LiNO₃, lithium perchlorate (LiClO₄), LiAlCl₄, LiBF₄, LiB(C₆H₅)₄, LiAsF₆, or lithium bis(oxalate)borate (LiBOB).

In accordance with another aspect of the disclosure, the electrolyte includes a lithium-based functional salt having a concentration of 0.05M to 0.6M.

In accordance with another aspect of the disclosure, the electrolyte includes a lithium-based functional salt having a concentration of 0.1M to 0.5M.

In accordance with another aspect of the disclosure, the electrolyte has a low-viscosity solvent including ethylene glycol dimethyl ether (DME).

In accordance with another aspect of the disclosure, the electrolyte has cyclic ether solvent including at least one of 1,3-dioxolane (DOL) or 1,4-dioxacyclohexane.

In accordance with another aspect of the disclosure, the electrolyte includes a cyclic ether solvent having less than 6 carbon atoms.

In accordance with another aspect of the disclosure, the electrolyte includes a solvent having a low-viscosity volume ratio including and between 50% to 100%.

In accordance with another aspect of the disclosure, the electrolyte includes a solvent having a low-viscosity volume ratio including and between 50% to 80%.

In accordance with another aspect of the disclosure, the electrolyte includes a solvent having a cyclic ether solvent volume ratio including and less than 50%.

In accordance with another aspect of the disclosure, the electrolyte includes a solvent having a cyclic ether solvent volume ratio including and between 20% and 50%.

According to several aspects of the present disclosure, a thick LFP-Li battery system is provided. The thick LFP-Li battery system includes a battery pack including a thick LFP cathode, a lithium-based anode, and an electrolyte. The thick LFP cathode has a capacity loading higher than 4 milliampere-hours per square centimeter (mAh/cm²). The lithium-based anode has a lithium content equal to or greater than 50%. The electrolyte includes a low-viscosity main salt, at least one lithium-based functional salt, and a solvent including a low viscosity solvent mixed with a cyclic ether solvent. The low-viscosity main salt includes at least one of LiTFSI or a lithium salt and has the following structure.

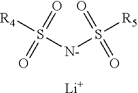

In accordance with another aspect of the disclosure, the thick LFP-Li battery system includes a thick LFP cathode having a binder including at least one of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), or styrene ethylene butylene styrene copolymer (SEBS).

In accordance with another aspect of the disclosure, the thick LFP-Li battery system has a lithium-based anode including metallic lithium.

In accordance with another aspect of the disclosure, the thick LFP-Li battery system has a lithium-based anode including at least one of a Li—Al alloy, a Li—Ag alloy, or a Li—Si alloy with a lithium content higher than 50 wt. %.

According to several aspects of the present disclosure, an electrolyte for a thick LFP-Li battery system is provided. The electrolyte for a thick LFP-Li battery system includes a low-viscosity main salt, at least one lithium-based functional salt, and a solvent including a low viscosity solvent mixed with a cyclic ether solvent. The low-viscosity main salt includes at least one of LiTFSI or a lithium salt and has the following structure.

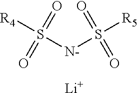

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle having a battery cell including an electrolyte having a low-viscosity main salt, at least one functional salt, a low-viscosity solvent, and a cyclic ether co-solvent, in accordance with the present disclosure.

FIG. 2 is a perspective view illustrating an example of the battery cell shown in FIG. 1, where the battery cell includes a thick LiFePO₄ cathode, an anode, and an electrolyte having a low-viscosity main salt, at least one functional salt, a low-viscosity solvent, and a cyclic ether co-solvent, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The following description is merely exemplary in nature and is not intended to limit the present disclosure, application, or uses.

An electrolyte for a thick LiFePO₄(LFP)—Li (“LFP”) battery and a battery pack is disclosed herein by using an ether as a component in the electrolyte. The electrolyte has a low viscosity and a high Li ion conductivity, which is beneficial when using a thick electrode to satisfy a wide C-rate range application. Moreover, striping and plating efficiency of an Li anode used in the battery system is largely improved when using the electrolyte disclosed herein. The electrolyte disclosed herein facilitates a thick LFP-Li battery with improved electrochemical performance.

Conventional LFP-Li battery systems often use a carbonate or carbonate-based electrolyte. The carbonate electrolyte has a relatively low viscosity and a high ionic conductivity, which has potential for thick-electrode batteries. However, the carbonate electrolyte is porous for lithium deposited. The pores accelerate a reaction between the lithium and the carbonate electrolyte resulting in a short battery life. In some instances, charge capacity and discharge capacity significantly drop after a short time (e.g., 50 cycles). Additionally, high concentration electrolytes are stable with a lithium anode and have a high lithium utilization rate. However, the high concentration electrolytes have both low ionic conductivity and high viscosity, which leads to poor rate performance. Thus, a high-performance electrolyte is desirable for thick LFP-Li battery systems.

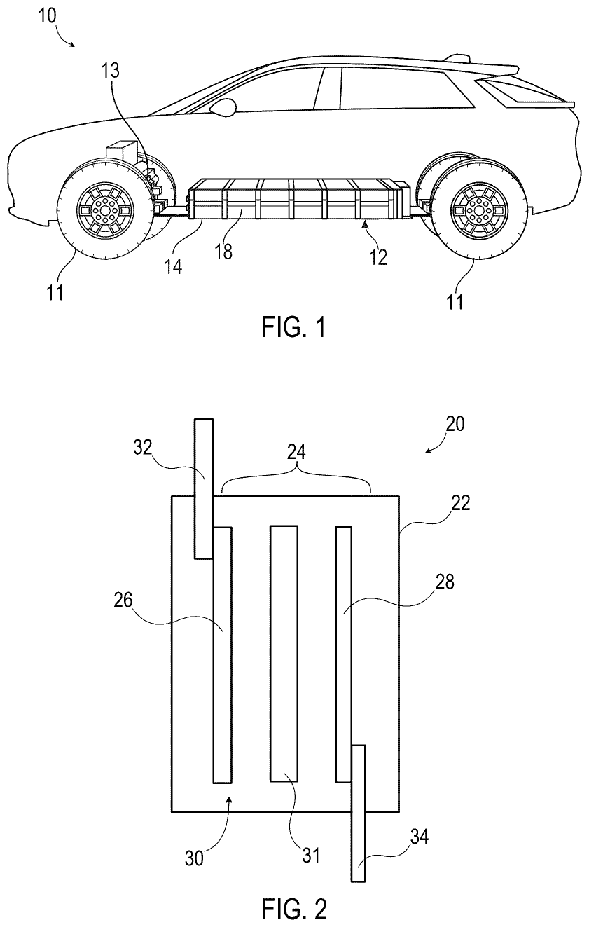

Referring to FIG. 1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 11 driven by electric motors/inverters 13. The electric motors/inverters 13 receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a case 14 for supporting a plurality of battery cells 18. In an example, the battery pack 12 may have fifty or more battery cells 18.

Referring now to FIG. 2, a perspective view illustrates a battery cell 20 disposed within the battery pack 12 shown in FIG. 1 (as battery cell 18), in accordance with an aspect of the present disclosure. Each battery cell 20 has a housing 22 or case, and at least one electrode stack 24, which further includes a thick LFP cathode 26, an anode 28, an electrolyte 30, and/or a separator 31. Each battery cell 20 may have tens or hundreds of electrode stacks 24. Each electrode stack 24 is connected to a current collector 32, 34. The electrode stacks are placed in the housing 22, which are filled with an electrolyte 30. The current collectors 32, 34 are thin metal plates or foils disposed on sides of the electrode stacks 24 and/or housing 22 and typically have a thickness between 5-50 micrometers (μm). The current collectors 32, 34 may be made of copper or aluminum and are attached to the electrode stacks 24 to transmit the electric current to an external circuit (not shown).

The cathode 26 includes a current collector 32 and an active cathode material comprises an olivine type cathode, such as LiFePO₄ (LFP) and LiMn₁₋ₓFeₓPO₄(LMFP). In a specific example, the cathode 26 includes an LFP cathode 26. The LFP cathode 26 uses lithium iron phosphate (LiFePO₄) as the cathode material. Lithium is the key element that enables the electrochemical reactions within the battery and serves as the source of positively charged ions that move back and forth between the anode and cathode during charging and discharging cycles. The lithium ions are embedded within the crystal structure of iron phosphate, providing a stable platform for intercalation and de-intercalation during charge and discharge. Iron phosphate provides a stable and robust platform for lithium ions to intercalate and de-intercalate during charge and discharge. The redox reaction involving iron ions (Fe²⁺/Fe³⁺) is responsible for the movement of electrons, leading to the flow of electric current. Iron phosphate (FePO₄) pairs with lithium cations (Li⁺) to form the lithium iron phosphate (LiFePO₄). The phosphate structure enhances the stability and safety of LFP batteries, reducing the risk of thermal runaway or combustion. LFP cathodes and batteries provide a consistent voltage level throughout discharge, ensuring steady performance in devices like electric vehicles and portable electronics. These cathodes and batteries can withstand thousands of charge cycles without significant degradation, making them cost-effective and reliable for long-term use. The cathode 26 may be prepared using a wet-coating process, a dry-film process, a dry-powder coating process, and the like.

The cathode 26 may include a binder or a combination of binders. Binders are used to hold the cathode material together in a compact and stable form within the battery cell. Some examples of a binder that may be included in the cathode 26 include poly(vinylidene fluoride) (PVDF), poly(vinylidene fluoride-co-hexafluoropropylene) (PVdF-HFP), polytetrafluoroethylene (PTFE), sodium carboxymethyl cellulose (CMC), styrene-butadiene rubber (SBR), styrene ethylene butylene styrene copolymer (SEBS), and the like. In one instance, a capacity loading of the cathode 26 is higher than 4 mAh/cm².

Still referring to FIG. 2, the anode electrode 28 includes an anode current collector 34 and an anode active material layer. The anode active material layer includes a metallic lithium or lithium alloy. For example, the anode 14 may include lithium aluminum (Li—Al), lithium silver (Li—Ag), and/or lithium silicon (Li—Si). The lithium content is equal to or higher than 50 wt. %.

Referring to FIG. 2, the battery pack 12 includes the electrolyte 30. The electrolyte 30 includes a low viscosity main salt, at least one functional salt, a low viscosity solvent, and a cyclic ether solvent. The electrolyte 30 transports charged ions between the anode 28 and the thick LFP cathode 26.

The low-viscosity main salt of the electrolyte 30 includes lithium bis(trifluoromethanesulfonyl)imide (LiTFSI) and/or a lithium salt with the structure shown below, where R₄ includes at least one of a fluorine (F) atom or a straight-chain C1-C6 fluoroalkyl group, and where R₅ includes at least one of a fluorine (F) atom or a straight-chain C1-C6 fluoroalkyl group.

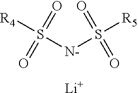

Additionally, a concentration of the low-viscosity main salt can be between about 0.6 mole/liter (M) to about 2.0M. In one example, a concentration of the low-viscosity main salt including LiTFSI is preferably between about 0.8M and about 1.2M. It will be appreciated that the concentration of the low-viscosity main salt may include other concentrations and ranges of those disclosed herein. In this context, the term “about” is known to those skilled in the art. Alternatively, the term “about” may be read to mean plus or minus 0.1M.

The functional salts facilitate formation of a solid electrolyte interphase (SEI) and formation of a cathode-electrolyte interphase (CEI). The functional salts may include at least one of lithium difluoro(oxalate)borate (LiDFOB), LiNO₃, lithium perchlorate (LiClO₄), LiAlCl₄, LiBF₄, LiB(C₆H₅)₄, LiAsF₆, or lithium bis(oxalate)borate (LiBOB). A concentration of the functional salts may be about 0.05M to about 0.6M. Preferably, the concentration of the functional salts may be about 0.1M to about 0.5M. In one example, the electrolyte 30 has multiple functional salts including LiDFOB with a concentration of about 0.2M and LiNO₃ with a concentration of about 0.3M. It will be appreciated by one skilled in the art that the functional salts may include other salts or combinations of salts having other concentrations than those listed herein. In the context of functional salts, the term “about” is known to those skilled in the art. Alternatively, the term “about” may be read to mean plus or minus 0.01M.

The electrolyte 30 for the thick LFP-Li battery cell 20 includes the low viscosity solvent. The low viscosity solvent includes ethylene glycol dimethyl ether (DME). The ethylene glycol dimethyl ether (DME) may have a concentration of between about 50% to about 100% of the overall solvent volume ratio. The overall solvent includes both the low viscosity solvent and the cyclic ether solvent. More preferably, the ethylene glycol dimethyl ether (DME) has a concentration of between about 50% to about 80% of the overall solvent volume. It will be appreciated by one skilled in the art that the low viscosity solvent may include other solvents having other concentrations than those listed herein. In the context of the low viscosity solvent, the term “about” is known to those skilled in the art. Alternatively, the term “about” may be read to mean plus or minus 1% of the overall solvent volume ratio.

The electrolyte 30 for the thick LFP-Li battery cell 20 includes the cyclic ether solvent (or co-solvent). The cyclic ether solvent includes a cyclic ether having less than 6 carbon atoms. For example, the cyclic ether solvent may include 1,4-dioxacyclohexane (4 carbon atoms) and/or 1,3-dioxolane (DOL) (3 carbon atoms). The cyclic ether solvent may include one or multiple cyclic ethers having a concentration range between about 0% to about 50% volume ratio of the overall solvent volume. Preferably, the solvent has a cyclic ether solvent volume ratio including and between 20% and 50%. In one example, the cyclic ether solvent includes a 1:1 ratio of DME to DOL. It will be appreciated by one skilled in the art that the cyclic ether solvent may include other cyclic ethers having other concentrations than those listed herein. In the context of the cyclic ether solvent, the term “about” is known to those skilled in the art. Alternatively, the term “about” may be read to mean plus or minus 1% of the overall solvent volume ratio.

The cyclic ether forms a polymer coating layer on a lithium surface of the anode 28 via a reaction of the cyclic ether with the lithium metal. The 1,4-dioxacyclohexane and/or the 1,3-dioxolane (DOL) are polymerized by way of a ring-opening reaction followed by formation of a ring-opening product chain.

The electrolyte 30 of the present disclosure is advantageous and beneficial over prior art carbonate electrolytes and battery packs using carbonate electrolytes. The electrolyte 30 has a low viscosity and a high Li ion conductivity, which is beneficial when using a thick electrode (i.e., the thick LFP cathode 26) to satisfy a wide C-rate range application. Moreover, striping and plating efficiency of the Li anode 28 used in the battery pack is largely improved when using the electrolyte 30 disclosed herein. The electrolyte disclosed herein enables a thick LFP-Li battery with improved electrochemical performance.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. An electrolyte for a thick LFP-Li battery system, comprising:
a low-viscosity main salt having a structure 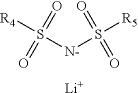
wherein the main salt includes at least one of LiTFSI or a lithium salt;
at least one lithium-based functional salt; and
a solvent including a low viscosity solvent mixed with a cyclic ether solvent.

2. The electrolyte of claim 1, wherein R₄ includes at least one of a fluorine (F) atom or a straight-chain C1-C6 fluoroalkyl group.

3. The electrolyte of claim 1, wherein R₅ includes at least one of a fluorine (F) atom or a straight-chain C1-C6 fluoroalkyl group.

4. The electrolyte of claim 1, wherein the low-viscosity main salt has a concentration between 0.6M to 2.0M.

5. The electrolyte of claim 4, wherein the low-viscosity main salt has a concentration between 0.8M to 1.2M.

6. The electrolyte of claim 1, wherein the lithium-based functional salt includes at least one of lithium difluoro(oxalate)borate (LiDFOB), LiNO₃, lithium perchlorate (LiClO₄), LiAlCl₄, LiBF₄, LiB(C₆H₅)₄, LiAsF₆, or lithium bis(oxalate)borate (LiBOB).

7. The electrolyte of claim 1, wherein the lithium-based functional salt has a concentration of 0.05M to 0.6M.

8. The electrolyte of claim 7, wherein the lithium-based functional salt has a concentration of 0.1M to 0.5M.

9. The electrolyte of claim 1, wherein the low-viscosity solvent includes ethylene glycol dimethyl ether (DME).

10. The electrolyte of claim 1, wherein the cyclic ether solvent includes at least one of 1,3-dioxolane (DOL) or 1,4-dioxacyclohexane.

11. The electrolyte of claim 1, wherein the cyclic ether solvent has less than 6 carbon atoms.

12. The electrolyte of claim 1, wherein the solvent has a low-viscosity volume ratio including and between 50% to 100%.

13. The electrolyte of claim 12, wherein the solvent has a low-viscosity volume ratio including and between 50% to 80%.

14. The electrolyte of claim 1, wherein the solvent has a cyclic ether solvent volume ratio including and less than 50%.

15. The electrolyte of claim 14, wherein the solvent has a cyclic ether solvent volume ratio including and between 20% and 50%.

16. A thick LFP-Li battery system, comprising:
a battery pack including
a thick LFP cathode having a capacity loading higher than 4 milliampere-hours per square centimeter (mAh/cm²);
a lithium-based anode having a lithium content equal to or greater than 50%; and
an electrolyte including
a low-viscosity main salt having a structure 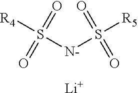
wherein the main salt includes at least one of LiTFSI or a lithium salt;
at least one lithium-based functional salt; and
a solvent including a low viscosity solvent mixed with a cyclic ether solvent.

17. The thick LFP-Li battery system of claim 16, wherein the thick LFP cathode has a binder including at least one of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), or styrene ethylene butylene styrene copolymer (SEBS).

18. The thick LFP-Li battery system of claim 16, wherein the lithium-based anode includes metallic lithium.

19. The thick LFP-Li battery system of claim 16, wherein the lithium-based anode includes at least one of a Li—Al alloy, a Li—Ag alloy, or a Li—Si alloy with a lithium content higher than 50 wt. %.

20. An electrolyte for a thick LFP-Li battery system, comprising:
a low-viscosity main salt having a structure 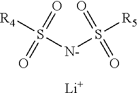
wherein the main salt includes at least one of LiTFSI or a lithium salt, wherein R₄ and R₅ includes at least one of a fluorine (F) atom or a straight-chain C1-C6 fluoroalkyl group, and wherein the low-viscosity main salt has a concentration between 0.8M to 1.2M;
at least one lithium-based functional salt including lithium difluoro(oxalate)borate (LiDFOB) having a concentration of 0.2M and LiNO₃ having a concentration of 0.3M; and
a solvent including a low viscosity solvent mixed with a cyclic ether solvent, wherein the solvent has a ratio of low viscosity solvent to cyclic ether solvent of 1:1, wherein the low-viscosity solvent includes ethylene glycol dimethyl ether (DME), and wherein the cyclic ether solvent includes at least one of 1,3-dioxolane (DOL) or 1,4-dioxacyclohexane.
